(19) United States
(12) Patent Application Publication
(10) Pub. No.: US 2008/0119162 A1
(43) Pub. Date: May 22, 2008

(54) SHARING PREPAID MOBILE TELEPHONY CREDIT AMONG A GROUP

(75) Inventors: Kadarkarai Sivalingam, Bangalore (IN); Puneet Gulati, New Delhi (IN)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/671,559

(22) Filed: Feb. 6, 2007

Related U.S. Application Data
(60) Provisional application No. 60/866,443, filed on Nov. 20, 2006.

(51) Int. Cl. H04M 11/00

(52) U.S. Cl. 455/408

(57) ABSTRACT

The present invention discloses a concept of a prepaid credit sharing group that includes a set of prepaid user accounts. A prepaid credit pool can be established for members of the prepaid group, where each group member is able to use credit from the pool and/or contribute credit to the pool. Group members can submit queries to dynamically determine credit balances available to the group. The prepaid group and individual accounts within the group can be centrally managed by an authorized group administrator. This administrator can also have authority to establish limitations and policies that are enforced for all group members.

### CROSS-REFERENCE TO RELATED APPLICATIONS

The present application claims the benefit of U.S. Provisional Application No. 60/866,443 filed 20 Nov. 2006, which is hereby incorporated by reference herein.

### BACKGROUND

1. Field of the Invention

The present invention relates to mobile telecommunications and, more particularly, to sharing prepaid mobile telephony credit among a group of prepaid user accounts.

2. Prepaid or “pay as you go” mobile telephony services allow users to pay in advance for wireless service. Prepaid services are often utilized by users who want to adhere to a budget or who want the advantages of being able to wirelessly communicate without incurring contractual obligations of postpaid wireless services. Freedom from contractual obligations allows users a level flexibility regarding phone use that is unavailable for postpaid service plans. Additionally, use of prepaid services prevents over usage problems and therefore is more “worry free” than subscription services.

One disadvantage of conventionally implemented prepaid phone services is that users often fall short of talk time when it is most needed. A shortage can occur, for example, during an important phone call or in an emergency situation. Shortages can be particularly problematic for users who are dependent on others, either financially or due to established policies, to recharge a prepaid phone. Waiting for another to recharge a prepaid phone can be inconvenient and can result in a potentially costly delay. Another disadvantage with conventional implementations is that managing several different prepaid accounts can be time consuming and inefficient, as each account needs to be separately handled and separately recharged with credit.

### SUMMARY OF THE INVENTION

The present invention discloses a concept of a prepaid credit sharing group that includes a set of prepaid user accounts. A prepaid credit pool can be established for members of the prepaid group, where each group member is able to use credit from the pool and/or contribute credit to the pool. Group members can submit queries to dynamically determine credit balances available to the group. The prepaid group and individual accounts within the group can be centrally managed by an authorized group administrator. This administrator can also have authority to establish limitations and policies that are enforced for all group members.

The present invention can be implemented in accordance with numerous aspects consistent with the material presented herein. For example, one aspect of the present invention can include a method for implementing prepaid mobile telephony user accounts. The method can include a step of registering multiple prepaid user accounts as a prepaid group. Each prepaid user account can be used to pay for mobile telephony services. Each use of a mobile telephony service can consume an amount of prepaid credit. A credit pool can be established that includes an amount of prepaid credit that is shared among the prepaid user accounts.

Another aspect of the present invention can include a method of handling prepaid mobile telephone credit. The method can establish a group of mobile telephone devices. Each device can utilize prepaid credit for calls. Prepaid credit amounts can be shared among the group, meaning that each mobile telephone device in the group is able to consume shared prepaid credit amounts to make calls.

Still another aspect of the present invention can include a system in which prepaid mobile telephony credit is shared. The system can include a credit pool and multiple user accounts. The credit pool can be a repository of prepaid credit for mobile telephony service. Each of the user accounts can be associated with a different mobile device. Use of the mobile device can consume an amount of prepaid credit from an associated user account. Each of the user accounts can utilize prepaid credit included in the credit pool. For example, a Subscriber Identity Module (SIM) or a Universal Subscriber Identity Module (USIM) included within a mobile device can obtain prepaid credits from the credit pool and/or donate prepaid credits to the credit pool.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for sharing prepaid mobile telephony credit among a group of user accounts in accordance with an embodiment of the inventive arrangements disclosed herein.

FIG. 2 is a schematic diagram of a system in which prepaid credit sharing is permitted among a defined user group.

FIG. 3 illustrates a prepaid credit graphical user interface (GUI) residing on a prepaid device, which participates in group credit sharing in accordance with an embodiment of the inventive arrangements disclosed herein.

FIG. 4 is a flow chart of a method for sharing prepaid credit among a group of user accounts in accordance with an embodiment of the inventive arrangements disclosed herein.

### DETAILED DESCRIPTION OF THE INVENTION

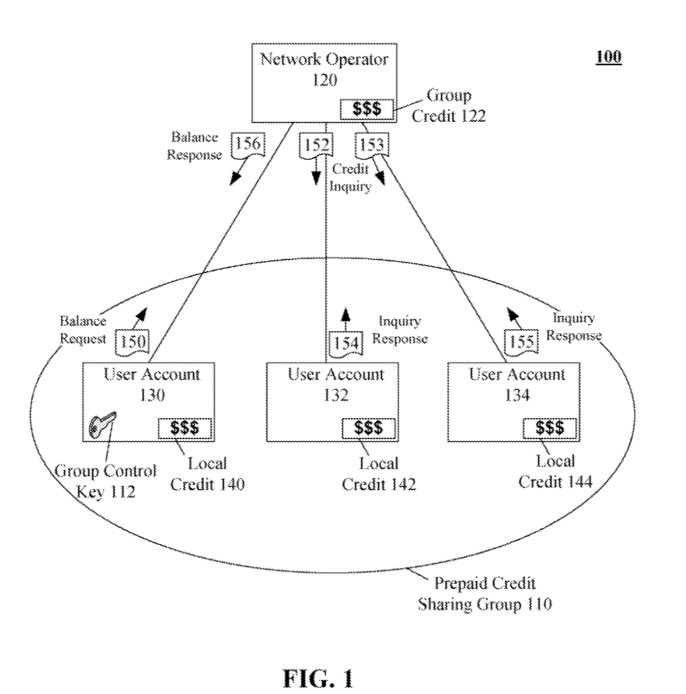

FIG. 1 is a schematic diagram of a system 100 for sharing prepaid mobile telephony credit among a group 110 of user accounts 130-134 in accordance with an embodiment of the inventive arrangements disclosed herein. Prepaid credit is mobile telephone credit that can be used for purchasing mobile telephony services. Use of prepaid credit does not require a user to be contractually obligated to a service provider, which is typically the case for postpaid mobile telephony services and service plans. Prepaid credit can be used for purchasing calling minutes, text messages, ring tones, songs and video, and other services. In one embodiment, group management functions and prepaid credit pools can be managed by a network operator 120, which provides wireless service to the mobile devices in exchange for prepaid credits. Credit sharing can be a for-fee service that incurs a service charge or can be implemented as a free value-added service provided by a network operator 120.

Advantages to the network operator 120 relating to prepaid credit sharing can include, but are not limited to, increased profit from credit sharing service charges, increased subscriber volume resulting from groups subscribing to a service together, and increased customer loyalty or retention. Advantages to account 130-134 users can include simplified prepaid credit acquisition and allocation, improved flexibility with prepaid mobile device group usage, and more efficient and centralized management of multiple accounts 130-134.

In system 100, a prepaid credit sharing group 110 can be established for any two or more user accounts 130-134. Groups 110 can be established for family members, business group members, a social group, or any other set of people. Each group 110 can be uniquely identified with a group identifier, which can be sent to mobile devices funded by the accounts 130-134. The unique identifier can be used to validate that the user account 130-134 is a member of group 110. A prepaid credit pool can be created for a group 110. This pool can include a virtual pool of shared credit that is otherwise fixed to specific accounts 130-134 and/or can include a repository of group credit 112, which is not fixed to a single user account 130-134.

For example, user account 130-134 information and account specific stores 140-144 of prepaid credit are commonly stored within a Subscriber Identity Module (SIM) or a Universal Subscriber Identity Module (USIM) inside a mobile device. Once locally stored 140-144 so that prepaid credit is available for use by the device, the prepaid credit is normally fixed or “locked” to that device. In system 100, however, prepaid credit amounts can be moved from a local credit store 140-144 to a different store 140-144 associated with another account 130-134 in the group 110.

In one embodiment, prepaid credit transfers can dynamically occur among stores 140-144 in an automated and user transparent fashion. Thus, from a user's perspective, available prepaid credits are defined by a virtual group credit pool, and not by prepaid credit amounts contained within a local credit store 140-144. In another embodiment, credit transfers can be a manual process requiring explicit user action. Further, explicit actions can be required not only from the credit receiving user, but also from a credit providing user.

For example, a user, such as a child of a family group 110, can manually request that fifty dollars in prepaid credit be transferred to credit store 140 from credit store 144, which might be a parent's prepaid credit store. A transfer request can be submitted to network operator 120, which sends a text-message to user account 134 requesting approval of the transfer. If approval is granted, indicated by a particular text-message response, then the transfer can be conducted. Otherwise, the transfer request can be denied. Assuming normal text-messaging rates apply, the network operator 120 can receive an inherent service charge for prepaid credit sharing based on these text messaging service charges. This arrangement provides users with an efficient and quick way to recharge a prepaid credit store 140-144, which doesn't require a credit card or other highly negotiable instrument to be possessed by the credit receiving user.

Another important credit sharing construct is the group credit store 122, which can contain an amount of prepaid credit available to any user account 130-134 in a related group 110. Prepaid credit in the store 122 can be allocated credit, meaning that it is not bound to a specific device or device store 140-144. Prepaid credit in store 122 can, for example, be stored in an external account maintained by operator 120 and not stored within a SIM card of any mobile device used by the group 110. Any device associated with a user account 130-134 can request and obtain prepaid credit from store 122, at which point it becomes bound to a local credit store 140-144. Prepaid credit can also be added to group credit store 122 from any one of the local credit stores 140-144.

The concept of a credit pool and/or a virtual credit pool can make determining available balances of prepaid credit an operation that requires cooperation and communication among group accounts 130-134. That is, a balance in a pool can depend upon an amount of credit included in each of the local credit stores 140-144 as well as an amount included in group credit store 122.

To illustrate, a balance request 150 can be sent from user account 130 to network operator 120. Upon receiving the request 150, the operator 120 can send a credit inquiry 152-153 to each other user account 132-134 in the group 110. Local credit stores 142 and 144 can be queried for balances, which are returned in inquiry responses 154 and 155. Amounts specified in responses 154-155 can be added to amounts included in group credit store 122, which results in a sum or balance of available group credit. This sum can be included in balance response 156, which is sent to user account 130.

Management responsibility for the group 110 can be implemented in a variety of manners. In one embodiment, group 110 can be essentially unmanaged, which means that no limit is placed upon any user account 130-134 and which also means that anyone in the group 110 can request balances, receive prepaid credit, and donate prepaid credit at will. In another embodiment, predetermined thresholds established at a time a group 110 is registered can exist. These thresholds can be fixed for each user account 130-134 and cannot be exceeded without operator 120 intervention.

Management responsibility of a group 110 can also be delegated to one or more group administrators or moderators. Each administrator can possess a group control key 112, which indicates that an associated account 130 or user is granted group administrative privileges. The key 112 can, for example, be stored in a SIM card of a mobile device used by a group administrator. The group administrator can establish group policies and limitations, which can be used to prevent any one user from taking a major portion of shared prepaid credit, which denies this credit to other group 110 members. Depending upon established policy settings, the group 110 administrator can require the network operator 120 to seek and receive explicit approval before fulfilling credit sharing requests submitted by other group 110 members. Explicit approval can be required only when a request exceeds a previously established threshold. Other requests can be granted automatically without this approval.

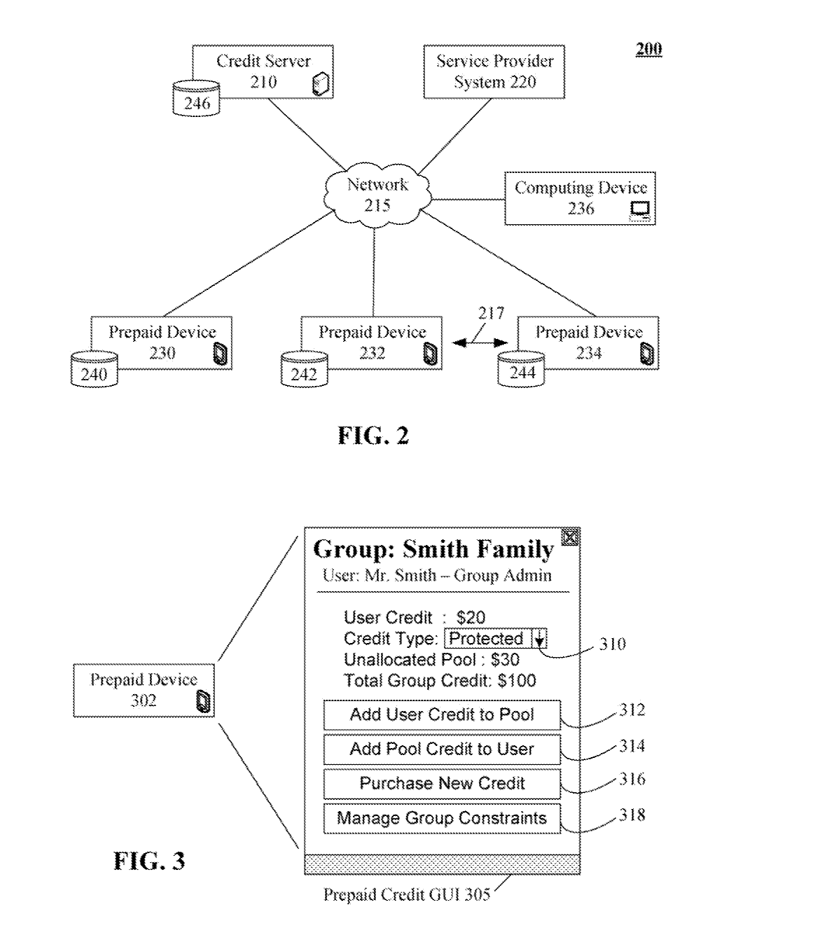

FIG. 2 is a schematic diagram of a system 200 in which prepaid credit sharing is permitted among a defined user group. System 200 shows one contemplated arrangement for implementing concepts discussed in system 100.

System 200 can include multiple prepaid devices 230-234, which are mobile telephony devices that receive wireless service from service provider system 220 over network 215. Each device 230-234 can be associated with a user account. Service usage by a device 230-234 can consume defined amounts of prepaid credit. Consumed credit amounts can be automatically deducted from the user accounts. Available prepaid credit amounts can be stored in a data store 240-244 local to a corresponding prepaid device 230-234. For example, prepaid amounts for each device 230-234 can be stored within a SIM contained within the device 230-234.

Devices 230-234 can be members of prepaid credit sharing group. Group membership entitles prepaid devices 230-234 to receive and donate prepaid credit to a group credit pool. The group credit pool can be a virtual pool that includes prepaid credit amounts contained in data stores 240-244. The group credit pool can also include credit contained in data store 246, which is an external pool of unbound credit maintained for the group. Unbound credit contained in data store 246 can be transferred to any of the data stores 240-244, upon request. Bound credit in data stores 240-244 can also be unbound and transferred to data store 246.

Credit server 210 can be a network 215 connected server that manages prepaid credit sharing operations. Credit server 210 can, for example, manage prepaid credit pools for devices 230-234. Server 210 assisted credit sharing operations can include, but are not limited to, group credit balance determinations, prepaid credit transfers, prepaid credit purchases, authorization operations, group reporting operations, group management operations, and the like.

In one embodiment, the credit server 210 can be implemented as part of the service provider system 220. The credit server 210 can, however, be implemented by a third party that is distinct from the network operator that controls system 220. For example, the credit server 210 can be a server operated by a managed service provider (MSP) that provides prepaid credit sharing services.

Management of group credit sharing policies can be conducted through one of the prepaid devices 230-234 or through another computing device 236 that is communicatively linked to network 215. Computing device 236 can be a desktop computer, a notebook computer, a tablet computer, or other such device. Managing group credit sharing policies using device 236 can be easier than performing the same functions from devices 230-234, since device 236 can include a more robust interactive interface than that available to a resource constrained mobile device 230-234.

It should be noted that while involvement of the credit server 210 can be required in client-server based implementations, other configurations of the disclosed invention exist, which do not require a presence of server 210. For example, credit sharing and group membership can be implemented in a peer-to-peer configuration, which involves direct communications between devices 230-234 over which prepaid credit can be shared. To illustrate, peer-to-peer communication channel 217 can be used to directly transfer prepaid credit between data store 242 and 244.

Network 215 can be used to communicatively link different components of system 200 to one another. Network 215 can include any hardware/software/and firmware necessary to convey data encoded within carrier waves. Network 215 can include one or more personal area network (PAN), local area network (LAN), metropolitan area network (MAN), wide area network (WAN), virtual private network (VPN), and the like. Network 215 can include a mobile telephony network, a Public Switched Telephone Network (PSTN), a data network (e.g., an Internet and/or one or more intranets), and the like. Network 215 can also include local components and data pathways necessary for communications to be exchanged among computing device components and between integrated device components and peripheral devices. The network 215 can include line based and/or wireless communication pathways.

Data stores 240-246 can by physically implemented within any type of hardware including, but not limited to, a magnetic disk, an optical disk, a semiconductor memory, a digitally encoded plastic memory, a holographic memory, or any other recording medium. Each data store 240-246 can be stand-alone storage units as well as a storage unit formed from a plurality of physical devices, which may be remotely located from one another. Additionally, information can be stored within each data store 240-246 in a variety of manners. For example, information can be stored within a database structure or can be stored within one or more files of a file storage system, where each file may or may not be indexed for information searching purposes.

FIG. 3 illustrates a prepaid credit graphical user interface (GUI) 305 residing on a prepaid device 302, which participates in group credit sharing in accordance with an embodiment of the inventive arrangements disclosed herein. The prepaid device 302 can be a device associated with user accounts 130, 132 and/or 134. Device 302 can also be any one of the prepaid devices 230-234. Elements shown in GUI 305 can be included in a GUI available to device 236, when device 236 is performing a group management function relating to prepaid credit.

GUI 305 provides information for a group identified as the Smith Family. The user of GUI 305 is Mr. Smith, who has been granted group administration privileges. Various group balances, including a user account specific credit of twenty dollars, an unallocated amount of credit in a group pool of thirty dollars, and a total group credit of one hundred dollars is shown. The total group credit of one hundred dollars indicates that an additional fifty dollars in credit is currently associated with different user accounts in the group.

Element 310 shows a selector for credit type. This selector can be used to indicate whether user credit, which is twenty dollars for Mr. Smith, is a protected amount that is isolated from the group pool of credit, is to be considered part of a group credit pool (virtual credit pool), and/or is able to be dynamically reallocated to other group members, should those members need additional credit.

Buttons 312-318 show possible credit related actions that can be performed by a user of GUI 305. Button 312 can permit the user to add an amount of credit to the pool. For example, ten dollars can be added to the pool, which would decrease the user credit amount from twenty dollars to ten dollars and would increase the unallocated pool amount from thirty dollars to forty dollars. Button 314 can perform the opposite function of transferring credit from the pool to the user. Button 316 can purchase additional credit, which can be selectively applied to either the user account or the group credit pool. Button 318 can permit the group administrator to perform a group management function, such as limiting an amount of credit which any one group member can extract from the group pool within a designated period.

It should be appreciated that the arrangements, layout, and control elements for GUI 305 have been provided for illustrative purposes only and derivatives and alternatives are contemplated herein and are to be considered within the scope of the present invention.

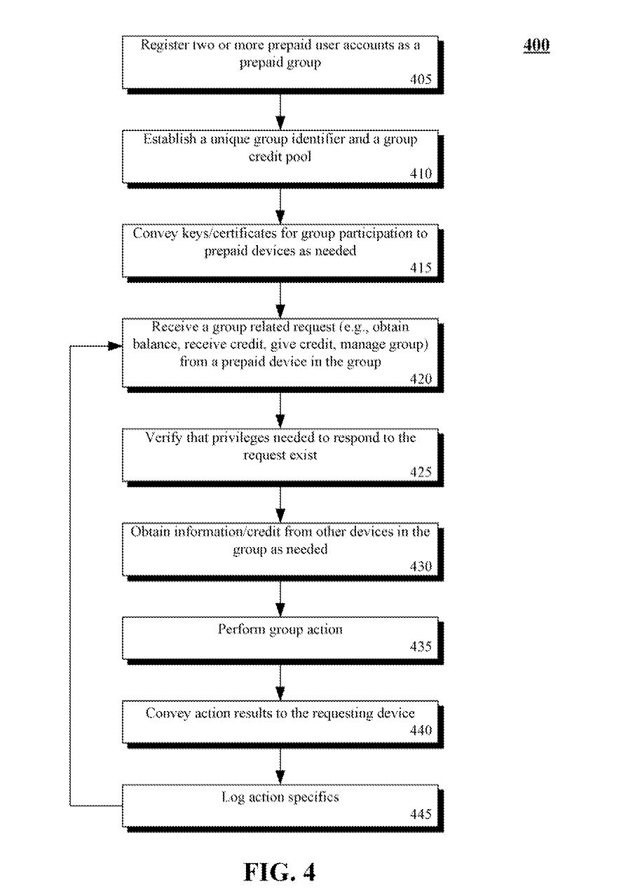

FIG. 4 is a flow chart of a method 400 for sharing prepaid credit among a group of user accounts in accordance with an embodiment of the inventive arrangements disclosed herein. Method 400 can be performed in the context of a system 100 and/or a system 200.

Method 400 can begin in step 405, when one or more prepaid user accounts are registered as a prepaid group. In step 410, a unique group identifier can be established for the group. A group-specific pool of prepaid credit can also be established. In optional step 415, security keys, certificates, or codes can be conveyed to devices used by each group member. These keys can be used by the devices to authenticate that they are authorized members of the group.

In step 420, a network operator or group managing server can receive a request from a prepaid device. The request can be for any credit sharing function, such as obtaining a balance, receiving credit from the group's credit pool, giving credit to the pool, managing group policies, and the like. In step 425, the network operator (or responsible server) can verify that the requesting device possesses sufficient privileges for the requested function. After successful verification, the method can proceed to step 430 where information and/or credit can be obtained from other devices in the group, as needed. For example, a request for a report of prepaid credit available for the group can require each mobile device in the group be queried for locally available credit.

In step 435, the network operator can initiate and/or perform one or more actions, which satisfy the request. In step 440, action results can be conveyed to the requesting device. The results of the action can adjust prepaid credit amounts in one or more of the devices in the group as well as adjusting the amount of credit available in the group credit pool. In step 445, action specifics and related values can be logged. The method can loop back to step 420, where another request can be received and processed.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for implementing prepaid mobile telephony user accounts comprising:
registering a plurality of prepaid user accounts as a prepaid group, where each prepaid user account is used to pay for mobile telephony services, where each use of the mobile telephony services consumes an amount of prepaid credit; and
established a credit pool that includes an amount of prepaid credit that is shared among the prepaid user accounts.

2. The method of claim 1, further comprising:
removing an amount of prepaid credit from the credit pool to pay for mobile telephony service charges associated with a first one of the user accounts; and
removing an amount of prepaid credit from the credit pool to pay for mobile telephony service charges associated with a different one of the user accounts.

3. The method of claim 1, further comprising:
transferring an amount of credit from one of the user accounts to the credit pool to make the transferred credit available to other user accounts.

4. The method of claim 1, further comprising:
one of the user accounts requesting a balance;
automatically querying each of the other user accounts for an amount of available prepaid credit associated with that account;
automatically adding results obtained by querying the other user accounts; and
automatically reporting the added results in response to the balance request.

5. The method of claim 1, further comprising:
presenting a graphical user interface upon a computing device, wherein the graphical user interface is configured to manage the prepaid user accounts and the credit pool.

6. The method of claim 1, further comprising:
specifying an account specific limitation imposed upon at least one of the prepaid user accounts, wherein said limitation limits an amount of prepaid credit that is able to be drawn from the credit pool for that account during a designated time.

7. The method of claim 1, wherein a network operator manages the credit pool and handles prepaid credit sharing actions for the user accounts responsive to requests received from mobile devices that perform said mobile telephony services, for which the user accounts pay.

8. The method of claim 1, wherein each of the user accounts is associated with a mobile device that includes an identity card, and wherein use of prepaid credit from the credit pool results in an amount of prepaid credit in at least one of the identity cards changing.

9. The method of claim 8, wherein the identity card included in each mobile device is at least one of a Subscriber Identity module (SIM) and a Universal Subscriber Identity Module (USIM).

10. The method of claim 1, wherein said steps of claim 1 are steps performed by at least one machine in accordance with at least one computer program stored within a machine readable memory, said computer program having a plurality of code sections that are executable by the at least one machine.

11. A method of handling prepaid mobile telephone credit comprising:
establishing a group of mobile telephone devices, each device utilizing prepaid credit for calls; and
sharing prepaid credit amounts among the group, where each mobile telephone device is able to consume shared prepaid credit amounts for calls.

12. The method of claim 11, further comprising:
permitting any of the mobile telephone devices to request balances for amounts of shared credit available to a requesting device.

13. The method of claim 11, further comprising:
centrally managing prepaid credit aspects for the group of mobile telephone devices.

14. The method of claim 11, further comprising:
establishing a pool of prepaid credit, which is not associated with a specific one of the mobile telephone devices;
permitting any of the mobile telephone devices to transfer credit to and from the established pool, which changes an amount of prepaid credit allocated to the mobile telephone device involved in the transfer.

15. The method of claim 11, further comprising:
establishing a virtual pool of prepaid credit, wherein the virtual pool includes the prepaid credit amounts of the sharing step, and wherein the virtual pool comprises amounts of prepaid credit associated with specific ones of the mobile telephone devices.

16. The method of claim 15, wherein when one of the mobile telephone devices consumes an amount of prepaid credit greater than an amount associated with that mobile telephone device, that mobile telephone device is able to draw upon prepaid credit contained in the virtual pool, and wherein drawing on prepaid credit results in a corresponding reduction in an amount of credit associated with other ones of the mobile telephone device from which prepaid credit was drawn.

17. The method of claim 11, wherein said steps of claim 11 are steps performed by at least one machine in accordance with at least one computer program stored within a machine readable memory, said computer program having a plurality of code sections that are executable by the at least one machine.

18. A system in which prepaid mobile telephony credit is shared comprising:
a credit pool of prepaid credit for mobile telephony service; and
a plurality of user accounts, each associated with a different mobile device, wherein use of the mobile device consumes an amount of prepaid credit from an associated user account, wherein each of the user accounts is able to utilize prepaid credit included in the credit pool.

19. The system of claim 18, further comprising:
a network operator that provides the mobile telephony service for the different mobile devices, wherein said network operator is configured to manage the credit pool and to handle prepaid credit sharing actions involving the credit pool.

20. The system of claim 18, further comprising:
a plurality of identity cards, each identity card being included within one of the different mobile devices, wherein use of prepaid credit from the credit pool results in an amount of prepaid credit it at least one of the identity cards changing, and wherein each identity card is at least one of a Subscriber Identity Module (SIM) and a Universal Subscriber Identity Module (USIM).
